(19) United States
(12) Patent Application Publication
(10) Pub. No.: US 2026/0187867 A1
(43) Pub. Date: Jul. 2, 2026

(54) TRAINING METHOD OF IMAGE GENERATION ALGORITHM, STORAGE MEDIUM, LASER RADAR, AND VEHICLE

(71) Applicant: HON HAI PRECISION INDUSTRY CO., LTD., New Taipei (TW)

(72) Inventor: CHUN-WEI LIU, New Taipei (TW)

(21) Appl. No.: 19/294,673

(22) Filed: Aug. 8, 2025

(30) Foreign Application Priority Data
Dec. 30, 2024 (CN) 202411965440.0

(51) Int. Cl. G06T 11/00; G01C 21/20; G01S 13/89; G06T 7/11; G06T 7/60; G06T 7/90

(52) U.S. Cl. CPC G06T 11/10; G01C 21/20; G01S 13/89; G06T 7/11; G06T 7/60; G06T 7/90; G06T 2207/10024; G06T 2207/10028; G06T 2207/20081; G06T 2207/20084; G06T 2210/56

(57) ABSTRACT

A training method of an image generation algorithm is provided. The image generation algorithm is applied to convert point cloud data into two-dimensional images. The training method includes: providing a plurality of sets of point cloud data of a test target; providing a plurality of sets of image data of the test target; converting the plurality of sets of point cloud data into a plurality of sets of two-dimensional data; performing machine learning training on the image generation algorithm by utilizing the plurality of sets of two-dimensional data and the plurality of sets of image data; and outputting the image generation algorithm after being trained.

### FIELD

The subject matter herein generally relates to a field of autonomous driving, particularly relates to a training method of an image generation algorithm, a storage medium, a laser radar, and a vehicle.

### BACKGROUND

An auto drive system of a vehicle usually includes sensors of different types, such as laser radar, camera, and millimeter wave radar. Due to limitations of the different types of sensors, the auto drive system often uses two or three types of sensors. For example, when using a laser radar combined with a camera, it is necessary to unify a coordinate system of image data obtained by the camera and point cloud data obtained by the laser radar, and then combine the image data and point cloud data. When using sensor combining method described above to obtain information, a storage resource and computing resource of the auto drive system control module are needed to perform the combination processes, thus occupying data of the auto drive system, and affecting the processing speed of the auto drive system.

Therefore, there is room for improvement in the art.

### BRIEF DESCRIPTION OF THE DRAWINGS

Implementations of the present technology will now be described, by way of embodiments only, with reference to the attached figures.

FIG. 1 is a flowchart of a training method according to an embodiment of the present disclosure.

FIG. 2 is a flowchart of converting multiple sets of point cloud data into multiple sets of two-dimensional data according to an embodiment of the present disclosure.

FIG. 3 is a flowchart of machine learning training of an image generation algorithm according to an embodiment of the present disclosure.

FIG. 4 is a flowchart of a training method according to another embodiment of the present disclosure.

FIG. 5 is a flowchart of verifying accuracy of the trained image generation algorithm in an embodiment of the present disclosure.

FIG. 6 is a schematic view of a laser radar according to an embodiment of the present disclosure.

FIG. 7 is a schematic view of a vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

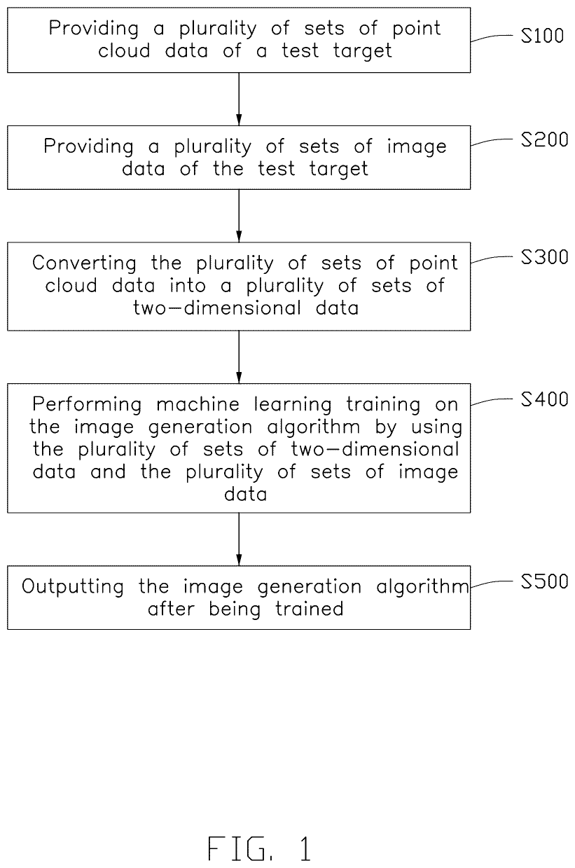

As shown in FIG. 1, the present embodiment provides a training method of an image generation algorithm. The training method of the image generation algorithm is applied to convert point cloud data into two-dimensional images. The training method includes the following step S100 to step S500.
Step S100: providing a plurality of sets of point cloud data of a test target.
Step S200: providing a plurality of sets of image data of the test target.
Step S300: converting the plurality of sets of point cloud data into a plurality of sets of two-dimensional data.
Step S400: performing machine learning training on the image generation algorithm by using the plurality of sets of two-dimensional data and the plurality of sets of image data.
Step S500: outputting a trained image generation algorithm after the image generation algorithm is trained.

The training method of the image generation algorithm provided in the embodiments of the present disclosure utilizes the plurality of sets of two-dimensional data and corresponding multiple sets of image data to machine learning training the image generation algorithm, and obtains image generation algorithm that can convert point cloud data into two-dimensional images and effectively convert point cloud data into two-dimensional images. When the image generation algorithm is applied to a laser radar, it can more effectively train the laser radar to output two-dimensional images, and can more effectively increase functions of the laser radar. When the laser radar is applied to an auto driving vehicle, it is conducive to reducing occupation of storage resources and computing resources of the auto drive system in the automatic driving vehicle, accelerating a processing speed of the auto drive system, extending a life of the auto drive system, and thus improving safety of the driving process.

Specifically, the step S100: providing the plurality of sets of point cloud data of the test target includes: providing three-dimensional coordinate information (x, y, z) of the plurality of sets of point cloud data of the test target; providing light intensity information of the plurality of sets of point cloud data of the test target; providing reflectivity information of the plurality of sets of point cloud data of the test target. In this embodiment, the three-dimensional coordinate information (x, y, z) of the plurality of sets of point cloud data of the test target is obtained by a laser radar. The point cloud data has three-dimensional features different from two-dimensional data, and the point cloud data is a set of vectors in a three-dimensional coordinate system. The light intensity information of the plurality of sets of point cloud data and the reflectivity information of the plurality of sets of point cloud data of the test target are obtained through different modes of the laser radar. The light intensity information and the reflectivity information are related to a surface material, roughness of the test target, incident angle direction, as well as the emission energy and laser wavelength of the laser radar. In other embodiments, the three-dimensional coordinate information (x, y, z), the light intensity information, and the reflectivity information of the plurality of sets of point cloud data of the test target can also be provided by a conventional training set, and this disclosure is not limited.

In the step S200, the image data refers to a set of pixel grayscale values/color information represented by numerical values. In this embodiment, the image data of the test target is collected by a camera and the image data exists in the form of images. In other embodiments, the image data containing pixel grayscale values/color information from conventional image databases can also be used. The plurality of sets of image data of the test target are used as a ground truth for machine learning training. Machine learning training includes three types: supervised learning, unsupervised learning, and semi supervised learning. In this embodiment, machine learning training may be supervised learning. In the machine learning training, each training data is labeled, the label includes input data and ground truth. The supervised learning is a process of deriving prediction functions from every labeled training data. In other embodiments, the unsupervised learning of machine learning training methods that infer conclusions from unlabeled training data can be used, or the semi supervised learning of machine learning training methods that combines the labeled training data and the unlabeled training data can also be used.

Specifically, in this embodiment, the step S100 providing the plurality of sets of point cloud data of the test target may be completed before the step S200 providing the plurality of sets of image data of the test target. In other embodiments, step S100 providing the plurality of sets of point cloud data of the test target may be completed after the step S200 providing the plurality of sets of image data of the test target. Since both the step S100 and the step S200 are to provide data, an order of the step S100 and the step S200 does not affect the execution of the training method of the image generation algorithm, and this disclosure does not limit it.

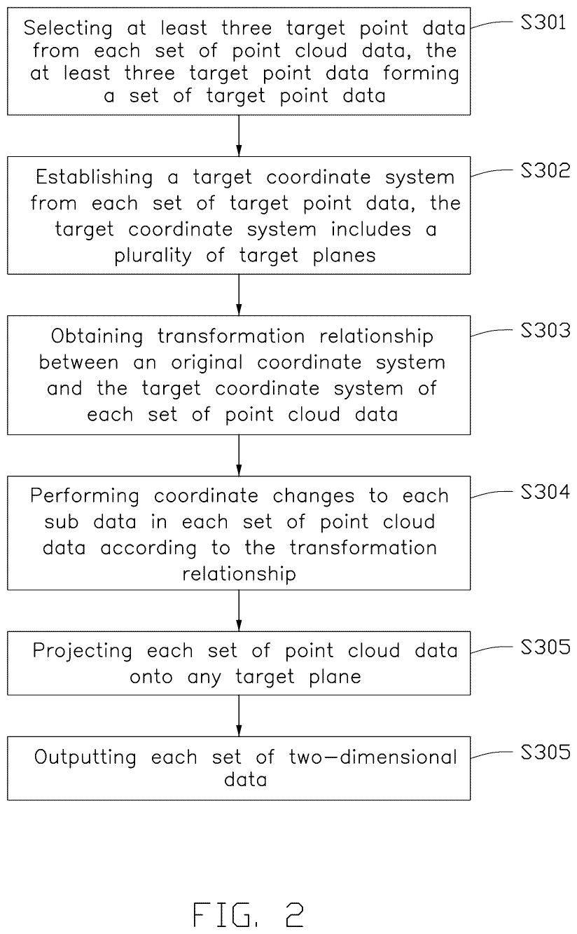

As shown in FIG. 2, the step S300, converting the plurality of sets of point cloud data into the plurality of sets of two-dimensional data includes the following step S301 to step S306.
Step S301: Selecting at least three target point data from each set of point cloud data, the at least three target point data forming a set of target point data.
Step S302: Establishing a target coordinate system from each set of target point data, the target coordinate system includes a plurality of target planes.
Step S303: Obtaining transformation relationship between an original coordinate system and the target coordinate system of each set of point cloud data.
Step S304: Performing coordinate changes to each sub data in each set of point cloud data according to the transformation relationship.
Step S305: Projecting each set of point cloud data onto any target plane.
Step S306: Outputting each set of two-dimensional data.

Specifically, in the step S301, each set of point cloud data is partitioned according to space, and at least three target point data are selected from each set of point cloud data. Partitioning each set of point cloud data according to space refers to using octree or other methods to partition each set of point cloud data according to spatial data structure of the point cloud data, obtaining A plurality of target point data, and the plurality of target point data form a set of target point data. In the step 302, the target coordinate system is established from each set of target point data mentioned above. In the step 302, the target coordinate system includes a plurality of target planes. Since the target coordinate system is three-dimensional, each coordinate axis divides the space into different target planes. In the step S305, each set of point cloud data is projected onto any target plane, with the purpose of reducing dimensionality of each point cloud data to obtain two-dimensional data. In this situation, the two-dimensional data does not have the three-dimensional spatial information represented by three-dimensional data, making it convenient to render the two-dimensional data according to attribute information of the two-dimensional data.

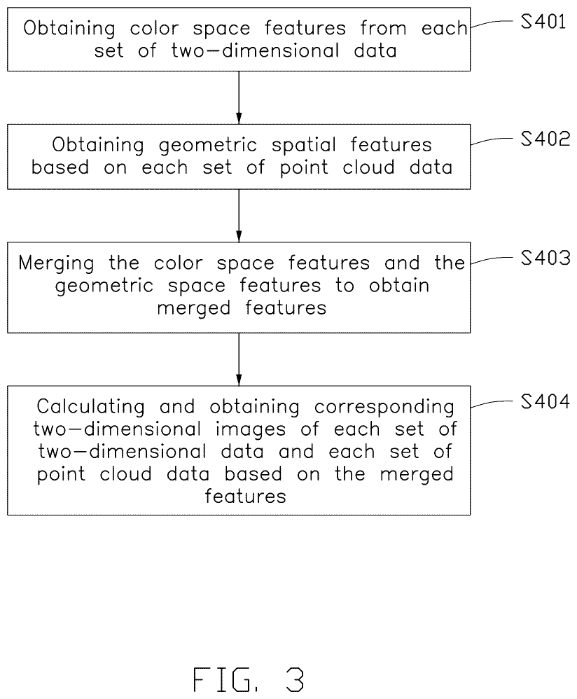

As shown in FIG. 3, the step S400 machine learning training of image generation algorithm by using the plurality of sets of two-dimensional data and corresponding sets of image data may include the following steps S401 to S404.
Step S401: Obtaining color space features from each set of two-dimensional data.
Step S402: Obtaining geometric spatial features based on each set of point cloud data.
Step S403: Merging the color space features and the geometric space features to obtain merged features.
Step S404: Calculating and obtaining corresponding two-dimensional images of each set of two-dimensional data and each set of point cloud data based on the merged features.

Specifically, in the step S401: obtaining color space features from each set of two-dimensional data includes using fully convolutional networks (FCN) algorithm to perform semantic segmentation to the two-dimensional data. Specifically, semantic segmentation is performed on two-dimensional data to obtain mask data; cropping the images corresponding to the two-dimensional data according to the mask data, and obtaining different semantic information of region images, and obtaining color space features according to the semantic information.

The step S402: obtaining geometric spatial features based on each set of point cloud data includes obtaining point cloud mask data from the three-dimensional coordinate information, performing feature transformation to the point cloud mask data to obtain local point cloud features and global point cloud features, and combining the local point cloud features and global point cloud features to obtain geometric spatial features.

In the step S404: calculating and obtaining corresponding two-dimensional images of each set of two-dimensional data and each set of point cloud data. The two-dimensional images include two-dimensional color images or two-dimensional grayscale images. The two-dimensional color image is an image with color combinations. The two-dimensional grayscale image is an image with a brightness hierarchy relationship.

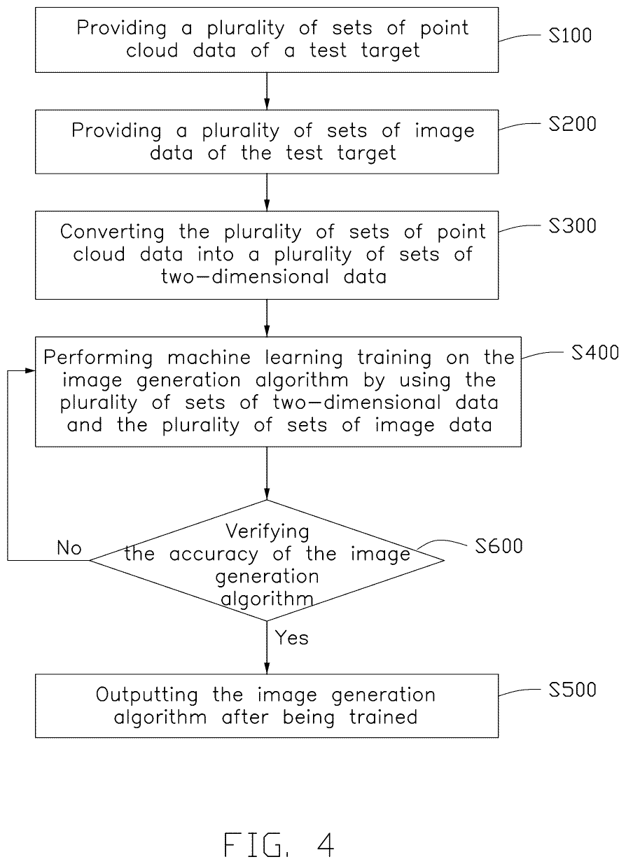

As shown in FIG. 4, the training method further includes a step S600 before the step S500: outputting the trained image generation algorithm. The step S600 may also include verifying accuracy of the trained image generation algorithm. The step S600 is executed after completing the step S400: machine learning training of image generation algorithm by using the plurality of sets of two-dimensional data and corresponding sets of image data. When the step S600 is executed to verify the accuracy of the trained image generation algorithm, if the accuracy meets requirements, the step S500: outputting the trained image generation algorithm is executed. If the accuracy does not meet the requirements, the step S400: machine learning training of image generation algorithm by utilizing the plurality of sets of two-dimensional data and corresponding sets of image data is executed.

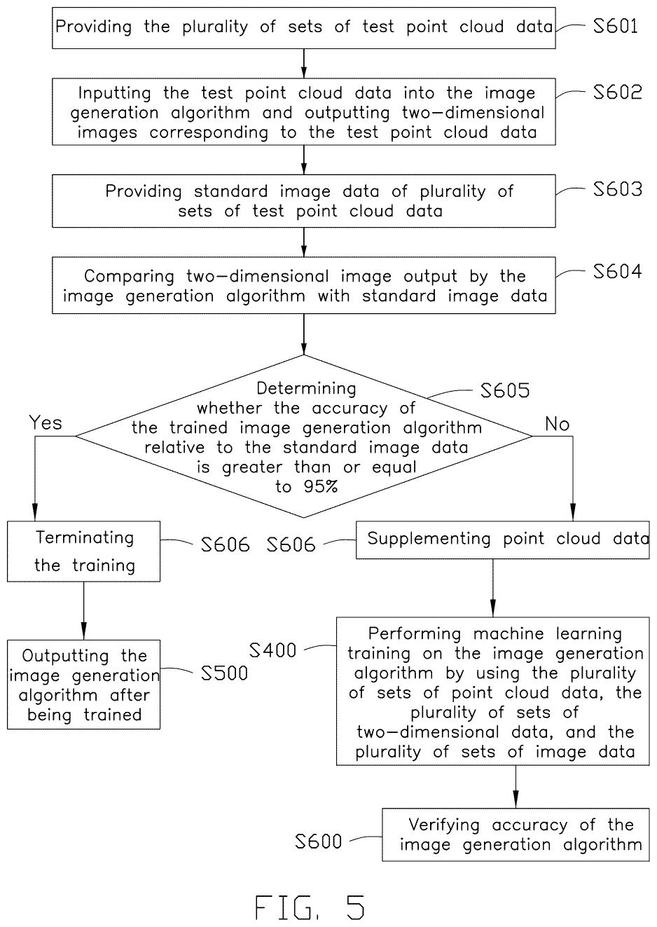

As shown in FIG. 5, the step S600: verifying the accuracy of the trained image generation algorithm may include step S601 to step S606.
Step S601: Providing the plurality of sets of test point cloud data.
Step S602: Inputting the test point cloud data into the image generation algorithm and outputting two-dimensional images corresponding to the test point cloud data.
Step S603: Providing standard image data of the plurality of sets of test point cloud data.
Step S604: Comparing two-dimensional image output by the image generation algorithm with standard image data.
Step S605: Determining whether the accuracy of the trained image generation algorithm relative to the standard image data is greater than or equal to 95%.
Step S606: If the accuracy of the trained image generation algorithm relative to the standard image data is greater than or equal to 95%, the training is terminated and the step S500 is executed to output the trained image generation algorithm. If the accuracy of the trained image generation algorithm relative to the standard image data is less than 95%, point cloud data of the test target should be supplemented; the step S400 is executed again to continue perform machine learning training on the image generation algorithm by using point cloud data from the plurality of sets of test targets, the plurality of sets of two-dimensional data, and corresponding the plurality of sets of image data; and the accuracy of the trained image generation algorithm is continued to be verified. Specifically, in the step S605, it is determined whether the accuracy of the trained image generation algorithm relative to the standard image data is greater than or equal to 95%. If the accuracy of the trained image generation algorithm relative to the standard image data is less than 95%, point cloud data of the test target is added, and actually additional reference information is added to the machine learning training, and the image generation algorithm is further trained by using the plurality of sets of point cloud data, the plurality of sets of two-dimensional data, and corresponding the plurality of sets of image data of the test target.

The storage medium of the present embodiment stores a program that can be executed by a processor to implement the training method of the image generation algorithm as described in any of the above embodiments. The type of the storage media includes but are not limited to phase change memory, static random-access memory, dynamic random-access memory, other types of random-access memory, read-only memory, electrically erasable programmable read-only memory or other optical storage, and magnetic storage. The storage media that can be used by a processor to perform any of the training methods described in the above embodiments are within the scope of protection of this disclosure.

The storage medium provided by the present embodiments can be used to implement the training method of the image generation algorithm in any of the above embodiments. The storage medium can more effectively train the laser radar to output two-dimensional images, is conducive to reducing occupation of storage resources and computing resources of the auto drive system, is conducive to accelerating the processing speed of the auto drive system, and is conducive to extending the life of the auto drive system.

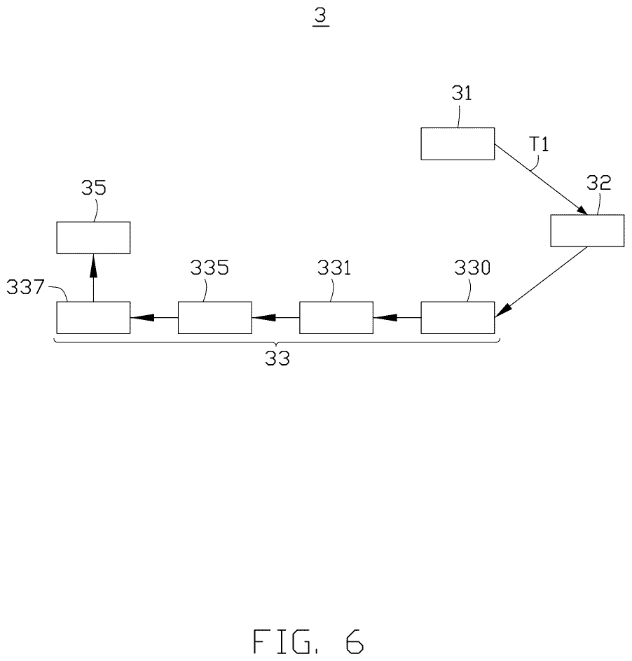

FIG. 6 illustrates a laser radar 3 of the present embodiment. The laser radar 3 includes an emission system 31, a receiving system 33, and a processor 35. The emission system 31 is used to transmit detection signal T1 to the test target 32. The receiving system 33 is used to receive the detection signal T1 reflected back from the test target 32, and convert the detection signal T1 into point cloud data. The processor 35 is used to receive point cloud data and convert the point cloud data into two-dimensional images by executing the image generation algorithm trained by the training method described in any of the above embodiments.

The emission system 31 can be any one of a liquid laser emission system, a gas laser emission system, and a solid laser emission system (fiber optic, semiconductor, all solid state, hybrid). The laser emission system may include a laser. The receiving system 33 may include a light receiving lens 330, an optical sensor 331, a transimpedance amplifier 335, and an analog-to-digital converter 337. The light receiving lens 330 is used to focus the reflected detection signal T1. The optical sensor 331 is used to receive the detection signal T1 emitted from the light receiving lens 330 and convert the detection signal T1 into electrical signal. The electrical signal is passed through the transimpedance amplifier 335, which is used to receive and amplify the electrical signal from the optical sensor 331. The electrical signal is finally passed through the analog-to-digital converter 337, which is used to convert continuous electrical signals into discrete electrical signals, thereby converting the detection signal T1 into point cloud data, facilitating signal processing and data conversion, and facilitating the calculation of the processor 35.

The laser radar of the present embodiment can output two-dimensional images by executing the image generation algorithm trained by the training method in any of the above embodiments, which is conducive to the diversification of the laser radar functions. When the laser radar is applied to an automatic driving vehicle, it is conducive to reducing a cost of the auto drive system, reducing the occupation of the storage resources and computing resources of the auto drive system, extending the life of the auto drive system, and effectively improving the safety of the driving process.

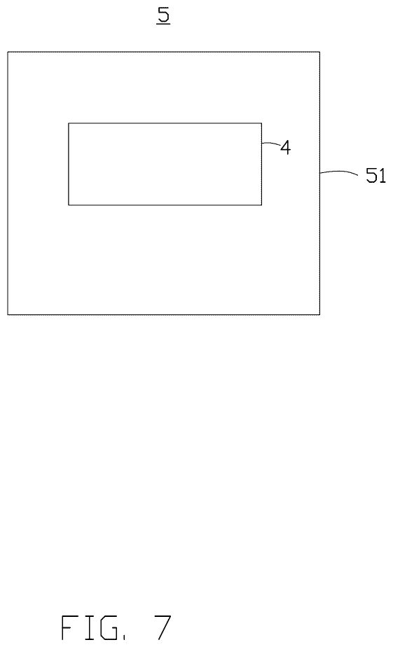

FIG. 7 illustrates a vehicle 5. The vehicle 5 includes a body 51, the laser radar 3 described in any of the above embodiments and an auto drive system 4. The auto drive system 4 is used to receive the point cloud data and two-dimensional images transmitted from the laser radar 3. The auto drive system 4 is used to formulate an autopilot route according to the point cloud data and two-dimensional images.

The vehicle 5 provided in this embodiment can be any one of an electric vehicle, gasoline vehicle, a diesel vehicle, and a hybrid vehicle. The body 51 may also include a positioning system (not shown) and a power system (not shown). The positioning system is used to obtain information of the automatic driving vehicle 5 by connecting the auto drive system 4. The auto drive system 4 is used to control automatic driving route of the vehicle 5 and adjust speeds and steering angles of the vehicle 5 in real time. The power system is used to adjust a motor speed in real time according to the information of the auto drive system 4. In other embodiments, the auto drive system 4 can be any one of an aircraft auto drive system, a ship auto drive system, a speedboat auto drive system, an automobile drive system, a motorcycle auto drive system, and a toy car auto drive system.

By using the laser radar 3 described in any of the above embodiments in the vehicle 5, it is conducive to reducing the cost of auto drive system 4, reducing the occupation of storage resources and computing resources of the auto drive system 4, extending the life of the auto drive system 4, and effectively improving the safety of driving process.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A training method of an image generation algorithm, the image generation algorithm applied to convert point cloud data into two-dimensional images, the training method comprising:
providing a plurality of sets of point cloud data of a test target;
providing a plurality of sets of image data of the test target;
converting the plurality of sets of point cloud data into a plurality of sets of two-dimensional data;
performing machine learning training on the image generation algorithm by utilizing the plurality of sets of two-dimensional data and the plurality of sets of image data; and
outputting a trained image generation algorithm after the image generation algorithm is trained.

2. The training method of claim 1, wherein converting the plurality of sets of point cloud data into a plurality of sets of two-dimensional data comprises:
selecting at least three target point data from each of the plurality of sets of point cloud data, the at least three target point data forming a set of target point data;
establishing a target coordinate system by the at least three target point data, wherein the target coordinate system comprises a plurality of target planes;
obtaining transformation relationship between an original coordinate system and the target coordinate system of each of the plurality of sets of point cloud data;
performing coordinate changes to each sub data in each of the plurality of sets of point cloud data according to the transformation relationship;
projecting each of the plurality of sets of point cloud data onto any of the plurality of target planes; and
outputting each of the plurality of sets of two-dimensional data.

3. The training method of claim 1, wherein performing machine learning training on the image generation algorithm comprises:
obtaining color space features from each of the plurality of sets of two-dimensional data;
obtaining geometric spatial features based on each of the plurality of sets of point cloud data;
merging the color space features and the geometric space features to obtain merged features;
calculating and obtaining corresponding two-dimensional images of each of the plurality of sets of two-dimensional data and each of the plurality of sets of point cloud data based on the merged features.

4. The training method of claim 3, wherein obtaining the color space features from each of the plurality of sets of two-dimensional data comprises: using fully convolutional networks algorithm to perform semantic segmentation to each of the plurality of sets of two-dimensional data.

5. The training method of claim 1, wherein providing the plurality of sets of point cloud data of the test target comprises:
providing three-dimensional coordinate information of the plurality of sets of point cloud data of the test target;
providing light intensity information of the plurality of sets of point cloud data of the test target; and
providing reflectivity information of the plurality of sets of point cloud data of the test target.

6. The training method of claim 1, further comprising verifying accuracy of the trained image generation algorithm before outputting the trained image generation algorithm, wherein verifying accuracy of the trained image generation algorithm comprises:
providing a plurality of sets of test point cloud data;
inputting each test point cloud data into the image generation algorithm and outputting two-dimensional images corresponding to the test point cloud data;
providing standard image data of the plurality of sets of test point cloud data;
comparing two-dimensional image output by the image generation algorithm with standard image data;
determining whether the accuracy of the trained image generation algorithm relative to the standard image data is greater than or equal to 95 %; and
if the accuracy of the trained image generation algorithm relative to the standard image data is greater than or equal to 95 %, terminating the machine learning training and outputting the trained image generation algorithm.

7. The training method of claim 6, wherein if the accuracy of the trained image generation algorithm relative to the standard image data is less than 95 %, the training method comprises:
adding point cloud data of the test target;
performing machine learning training on the image generation algorithm by utilizing the plurality of sets of point cloud data, the plurality of sets of two-dimensional data, and the plurality of sets of image data;
verifying accuracy of the trained image generation algorithm.

8. A storage medium storing a program executed by a processor to implement a training method of an image generation algorithm, the image generation algorithm applied to convert point cloud data into two-dimensional images, the training method comprising:
providing a plurality of sets of point cloud data of a test target;
providing a plurality of sets of image data of the test target;
converting the plurality of sets of point cloud data into a plurality of sets of two-dimensional data;
performing machine learning training on the image generation algorithm by utilizing the plurality of sets of two-dimensional data and the plurality of sets of image data; and
outputting a trained image generation algorithm after the image generation algorithm is trained.

9. The storage medium of claim 8, wherein converting the plurality of sets of point cloud data into a plurality of sets of two-dimensional data comprises:
selecting at least three target point data from each of the plurality of sets of point cloud data, the at least three target point data forming a set of target point data;
establishing a target coordinate system by the at least three target point data, wherein the target coordinate system comprises a plurality of target planes;
obtaining transformation relationship between an original coordinate system and the target coordinate system of each of the plurality of sets of point cloud data;
performing coordinate changes to each sub data in each of the plurality of sets of point cloud data according to the transformation relationship;
projecting each of the plurality of sets of point cloud data onto any of the plurality of target planes; and
outputting each of the plurality of sets of two-dimensional data.

10. The storage medium of claim 8, wherein performing machine learning training on the image generation algorithm comprises:
obtaining color space features from each of the plurality of sets of two-dimensional data;
obtaining geometric spatial features based on each of the plurality of sets of point cloud data;
merging the color space features and the geometric space features to obtain merged features;
calculating and obtaining corresponding two-dimensional images of each of the plurality of sets of two-dimensional data and each of the plurality of sets of point cloud data based on the merged features.

11. The storage medium of claim 10, wherein obtaining the color space features from each of the plurality of sets of two-dimensional data comprises: using fully convolutional networks algorithm to perform semantic segmentation to each of the plurality of sets of two-dimensional data.

12. The storage medium of claim 8, wherein providing the plurality of sets of point cloud data of the test target comprises:
providing three-dimensional coordinate information of the plurality of sets of point cloud data of the test target;
providing light intensity information of the plurality of sets of point cloud data of the test target; and
providing reflectivity information of the plurality of sets of point cloud data of the test target.

13. The storage medium of claim 8, wherein the training method comprises verifying accuracy of the trained image generation algorithm before outputting the trained image generation algorithm, wherein verifying accuracy of the trained image generation algorithm comprises:
providing a plurality of sets of test point cloud data;
inputting each test point cloud data into the image generation algorithm and outputting two-dimensional images corresponding to the test point cloud data;
providing standard image data of the plurality of sets of test point cloud data;
comparing two-dimensional image output by the image generation algorithm with standard image data;
determining whether the accuracy of the trained image generation algorithm relative to the standard image data is greater than or equal to 95%;
if the accuracy of the trained image generation algorithm relative to the standard image data is greater than or equal to 95%, terminating the training machine learning and outputting the trained image generation algorithm;
if the accuracy of the trained image generation algorithm relative to the standard image data is less than 95%, the training method comprising:
adding point cloud data of the test target;
performing machine learning training on the image generation algorithm by utilizing the plurality of sets of point cloud data, the plurality of sets of two-dimensional data, and the plurality of sets of image data;
verifying accuracy of the trained image generation algorithm.

14. A laser radar comprising:
an emission system configured to transmit a detection signal to a test target;
a receiving system configured to receive the detection signal reflected back from the test target, and convert the reflected detection signal into point cloud data; and
a processor configured to receive the point cloud data and convert the point cloud data into two-dimensional images by executing an image generation algorithm trained by a training method, the training method comprising:
providing a plurality of sets of point cloud data of a test target;
providing a plurality of sets of image data of the test target;
converting the plurality of sets of point cloud data into a plurality of sets of two-dimensional data;
performing machine learning training on the image generation algorithm by utilizing the plurality of sets of two-dimensional data and the plurality of sets of image data; and
outputting the image generation algorithm after being trained.

15. The laser radar of claim 14, wherein converting the plurality of sets of point cloud data into a plurality of sets of two-dimensional data comprises:
selecting at least three target point data from each of the plurality of sets of point cloud data, the at least three target point data forming a set of target point data;
establishing a target coordinate system by the at least three target point data, wherein the target coordinate system comprises a plurality of target planes;
obtaining transformation relationship between an original coordinate system and the target coordinate system of each of the plurality of sets of point cloud data;
performing coordinate changes to each sub data in each of the plurality of sets of point cloud data according to the transformation relationship;
projecting each of the plurality of sets of point cloud data onto any of the plurality of target planes; and
outputting each of the plurality of sets of two-dimensional data.

16. The laser radar of claim 14, wherein performing machine learning training on the image generation algorithm comprises:
obtaining color space features from each of the plurality of sets of two-dimensional data;
obtaining geometric spatial features based on each of the plurality of sets of point cloud data;
merging the color space features and the geometric space features to obtain merged features;
calculating and obtaining corresponding two-dimensional images of each of the plurality of sets of two-dimensional data and each of the plurality of sets of point cloud data based on the merged features.

17. The laser radar of claim 16, wherein obtaining the color space features from each of the plurality of sets of two-dimensional data comprises: using fully convolutional networks algorithm to perform semantic segmentation to each of the plurality of sets of two-dimensional data.

18. The laser radar of claim 14, wherein providing the plurality of sets of point cloud data of the test target comprises:
providing three-dimensional coordinate information of the plurality of sets of point cloud data of the test target;
providing light intensity information of the plurality of sets of point cloud data of the test target; and
providing reflectivity information of the plurality of sets of point cloud data of the test target.

19. The laser radar of claim 14, wherein the training method further comprises verifying accuracy of the trained image generation algorithm before outputting the trained image generation algorithm, verifying accuracy of the trained image generation algorithm comprises:
providing a plurality of sets of test point cloud data;
inputting each test point cloud data into the image generation algorithm and outputting two-dimensional images corresponding to the test point cloud data;
providing standard image data of the plurality of sets of test point cloud data;
comparing two-dimensional image output by the image generation algorithm with standard image data;
determining whether the accuracy of the trained image generation algorithm relative to the standard image data is greater than or equal to 95%;
if the accuracy of the trained image generation algorithm relative to the standard image data is greater than or equal to 95%, terminating the training and outputting the trained image generation algorithm;
if the accuracy of the trained image generation algorithm relative to the standard image data is less than 95%, the training method comprising:
adding point cloud data of the test target;
performing machine learning training on the image generation algorithm by using the plurality of sets of point cloud data, the plurality of sets of two-dimensional data, and the plurality of sets of image data;
verifying accuracy of the trained image generation algorithm.

20. A vehicle comprising:
a body;
the laser radar of claim 14; and
an auto drive system used to receive the point cloud data and the two-dimensional images from the laser radar, and formulate an autopilot route according to the point cloud data and the two-dimensional images.
